(19) United States
(12) Patent Application Publication
(10) Pub. No.: US 2012/0141819 A1
(43) Pub. Date: Jun. 7, 2012

(54) POROUS SILICON ARTICLE AND ABOUT METHOD FOR MANUFACTURING SAME

(75) Inventors: HSIN-PEI CHANG, Tu-Cheng (TW); WEN-RONG CHEN, Tu-Cheng (TW); HUANN-WU CHIANG, Tu-Cheng (TW); CHENG-SHI CHEN, Tu-Cheng (TW); SHUN-MAO LIN, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD, Shenzhen City (CN)

(21) Appl. No.: 13/217,906

(22) Filed: Aug. 25, 2011

(30) Foreign Application Priority Data
Dec. 1, 2010 (CN) 201010568125.6

(51) Int. Cl. B32B 5/18; C25F 3/02

(52) U.S. Cl. 428/613; 205/640

(57) ABSTRACT

A porous silicon article includes a substrate; a silicon metal layer formed on the substrate; and about a porous silicon layer formed on the silicon metal layer. The silicon metal layer is a silicon layer doped with M that is at least one element selected from a group consisting of aluminum, magnesium and about calcium, the content of M in the silicon metal layer is between about 30 wt % and about 50 wt %.

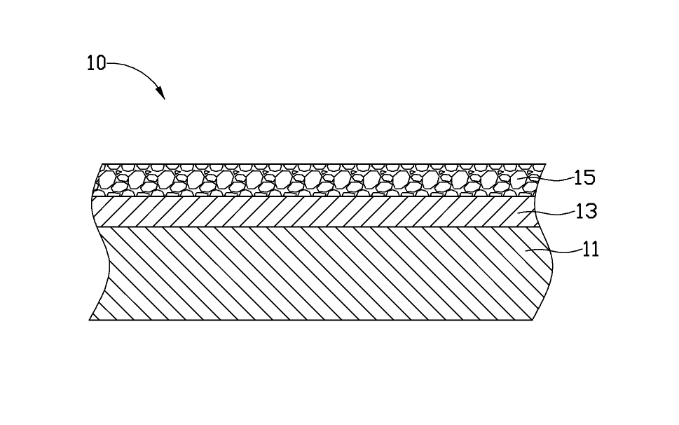

### CROSS-REFERENCE TO RELATED APPLICATIONS

The present application is related to co-pending U.S. Patent Applications (Attorney Docket No. US35738, US39194), each entitled “POROUS METAL ARTICLE AND ABOUT METHOD FOR MANUFACTURING SAME”, by Zhang et al. These applications have the same assignee as the present application and about have been concurrently filed herewith. The above-identified applications are incorporated herein by reference.

### BACKGROUND

1. Technical Field

The exemplary disclosure generally relates to porous silicon articles and about methods for manufacturing the porous silicon articles.

2. Description of Related Art

Porous silicon is a form of the chemical element silicon which has nano-porous holes in its microstructure. It is possible to obtain porous silicon by stain-etching silicon with hydrofluoric acid, nitric acid and water. Porous silicon formation by stain-etching is particularly attractive because of its simplicity and the presence of readily available corrosive reagent. However, hydrofluoric acid is poisonous and highly corrosive so it is dangerous to use to etch silicon substrate.

Therefore, there is room for improvement within the art.

### BRIEF DESCRIPTION OF THE DRAWINGS

Many aspects of the exemplary embodiments can be better understood with reference to the following drawings. The components in the drawings are not necessarily drawn to scale, the emphasis instead being placed upon clearly illustrating the principles of the exemplary exemplary embodiment of a porous silicon article and method for manufacturing the porous silicon article. Moreover, in the drawings like reference numerals designate corresponding parts throughout the several views. Wherever possible, the same reference numbers are used throughout the drawings to refer to the same or like elements of an exemplary embodiment.

The FIGURE illustrates a cross-sectional view of an exemplary embodiment of a porous silicon article.

### DETAILED DESCRIPTION

Referring to FIGURE, an exemplary method for manufacturing a porous silicon article 10 may include the least the following steps.

Providing a substrate 11, which comprises plastic or stainless steel.

The substrate 11 is pretreated. For example, the substrate 11 may be washed with a solution (e.g., NaOH), and then washed with a deionized water, to remove grease, dirt, and/or impurities, followed by drying.

A green coating is deposited on the substrate 11 in a vacuum sputtering coating machine by physical vapor deposition, such as, magnetron sputtering or cathodic arc deposition. The green coating is a silicon layer co-doped with M, wherein M comprises at least one element selected from a group consisting of aluminum, magnesium and calcium. The content of M in the green coating is between about 10 wt % and about 50 wt % of the total weight of silicon, M. The vacuum sputtering coating machine includes a sputtering coating chamber with a target located in the sputtering coating chamber. The target is a silicon metal alloy, the metal is at least one element selected from a group consisting of aluminum, magnesium and calcium, the content of metal in the green coating is between about 10 wt % and about 50 wt % of the total weight of silicon, metal. During depositing, the temperature in the sputtering coating chamber is set between about 30 degree Celsius (° C.) and about 70° C. when the substrate 11 is made of plastic, or set between about 30° C. and about 150° C. when the substrate 11 is made of stainless steel. Argon is fed into the sputtering coating chamber at a flux between about 150 Cubic Centimeters per Minute (sccm) and about 500 sccm. When the green coating is deposited by magnetron sputtering, the target is evaporated at a power between about 5 kW and about 11 kW for about 60˜300 minutes. When the green coating is deposited by cathodic arc deposition it is evaporated at a power between about 1.5 kW and about 5 kW for about 20˜80 minutes. A bias voltage applied to the substrate 11 comprises between about 0 volts and about −250, to deposit the green coating on the substrate 11. The green coating has a thickness between about 1 micrometer and about 6 micrometers.

The green coating on the substrate 11 is electrochemically etched to remove M in an outer surface of the green coating to form a porous silicon layer 15 on the outer surface of the green coating. The portion of the green coating from which M is not removed forms a silicon-based metal layer 13 on the substrate 11. During electrochemical etching, the green coating acts as anode, and about a platinum plate acts as a cathode, using hydrochloric acid, formic acid, acetic acid, oxalic acid or sulphuric acid as electrolyte. The content of the hydrochloric acid or sulphuric acid is between about 3 wt % and about 15 wt % of the total weight of the electrolyte. A constant power applied between the anode and the cathode may have a voltage between about 2 volts and about 5 volts, a current density between about 0.5 mA/cm2 and about 4 mA/cm² for about 3 minutes to about 20 minutes to form the porous silicon layer 15. The porous silicon layer 15 has a thickness between about 1 micrometers and about 3 micrometers. The porous silicon layer 15 defines a plurality of nano-pores, and each nano-pore has a pore opening size between about 50 nanometers (nm) and about 150 nm.

The porous silicon article 10 manufactured by the present method includes a substrate 11, a silicon-based metal layer 13 formed on the substrate 11, and a porous silicon layer 15 on the silicon-based metal layer 13. The substrate 11 may be made of stainless steel or plastic. The silicon-based metal layer 13 is a silicon layer doped with M, wherein M may be at least one element selected from a group consisting of aluminum, magnesium and calcium. The content of M in the silicon metal layer 13 is between about 10 wt % and about 50 wt % of the total weight of silicon, M. The silicon metal layer 13 has a thickness between about 0.5 micrometers and about 1 micrometer. The porous silicon layer 15 has a thickness between about 1 micrometers and about 3 micrometers. The porous silicon layer 15 defines a plurality of nano-pores, and about each nano-pore has a pore opening size between about 50 nanometers (nm) and about 150 nm.

Using hydrochloric acid or sulphuric acid to substitute for hydrofluoric acid allows the present method to avoid producing poisonous SiF₄, which is produced when typical hydrofluoric acid is used as electrolyte.

It is to be understood, however, that even through numerous characteristics and advantages of the exemplary disclosure have been set forth in the foregoing description, together with details of the system and function of the disclosure, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. A porous silicon article, comprising:
a substrate;
a silicon-based metal layer formed on the substrate; and
a porous silicon layer formed on the silicon metal layer;
wherein the silicon-based metal layer is a silicon layer doped with M, M comprising at least one element selected from a group consisting of aluminum, magnesium and calcium, the content of M in the silicon-based metal layer is between about 10 wt % and about 50 wt %.

2. The porous silicon article as claimed in claim 1, wherein the substrate is made of stainless steel or plastic.

3. The porous silicon article as claimed in claim 1, wherein the silicon-based metal layer has a thickness between about 0.5 micrometers and about 1 micrometer.

4. The porous silicon article as claimed in claim 1, wherein the porous silicon layer has a thickness between about 1 micrometers and about 3 micrometers.

5. The porous silicon article as claimed in claim 1, wherein the porous silicon layer defines a plurality of nano-pores, and each nano-pore has a pore opening size between about 50 nm and about 150 nm.

6. A method for manufacturing a porous silicon article comprising steps of:
providing a substrate;
depositing a green coating on the substrate by physical vapor deposition, the green coating including silicon and M in which M is at least one element selected from a group consisting of aluminum, magnesium and calcium, the content of M in the green coating is between about 10 wt % and about about 50 wt %; and about
electrochemical etching the green coating to remove M in an outer surface of the green coating to form a porous silicon layer on the outer surface of the green coating using hydrochloric acid, formic acid, acetic acid, oxalic acid or sulphuric acid as electrolyte.

7. The method of claim 6, wherein the substrate is made of plastic or stainless steel.

8. The method of claim 6, wherein the green coating is deposited on the substrate in a vacuum sputtering coating machine by magnetron sputtering, the vacuum sputtering coating machine includes a sputtering coating chamber with a target located in the sputtering coating chamber, the target is a silicon metal alloy, the metal is at least one element selected from a group consisting of aluminum, magnesium and calcium, the content of metal in the green coating is between about 10 wt % and about 50 wt % of the total weight of silicon, metal.

9. The method of claim 8, wherein during depositing, the temperature in the sputtering coating chamber is set between about 30° C. and about 70° C. when the substrate is made of plastic, or set between about 30° C. and about 150° C. when the substrate is made of stainless steel; argon is fed into the sputtering coating chamber at a flux between about 150 sccm and about 500 sccm; the target is evaporated at a power between about 5 kW and about 11 kW for about 60˜300 minutes; a bias voltage applied to the substrate is between about 0 volts and about −250, to deposit the green coating on the substrate.

10. The method of claim 6, wherein the green coating is deposited on the substrate in a vacuum sputtering coating machine by cathodic arc deposition, the vacuum sputtering coating machine includes a sputtering coating chamber with a target located in the sputtering coating chamber, the target is a silicon metal alloy, the metal is at least one element selected from a group consisting of aluminum, magnesium and calcium, the content of metal in the green coating is between about 10 wt % and about 50 wt % of the total weight of silicon, metal.

11. The method of claim 10, wherein the temperature in the sputtering coating chamber is set between about 30° C. and about 70° C. when the substrate is made of plastic, or set between about 30° C. and about 150° C. when the substrate is made of stainless steel; argon is fed into the sputtering coating chamber at a flux between about 150 sccm and about 500 sccm; the target is evaporated at a power between about 1.5 kW and about 5 kW for about 20˜80 minutes; a bias voltage applied to the substrate is between about 0 volts and about −250, to deposit the green coating on the substrate.

12. The method of claim 6, wherein the green coating has a thickness between about 1 micrometer and about and about 6 micrometers.

13. The method of claim 6, wherein during electrochemical etching, the green coating acts as anode, a platinum plate acts as cathode, using hydrochloric acid or sulphuric acid as electrolyte.

14. The method of claim 13, wherein the content of the hydrochloric acid or sulphuric acid is between about 3 wt % and about 15 wt % of the total weight of the electrolyte.

15. The method of claim 13, wherein a constant power applied between about the anode and about the cathode may have a voltage between about 2 volts and about 5 volts, a current density between about 0.5 mA/cm2 and about 4 mA/cm² for about 3 minutes to about 20 minutes to form the porous silicon layer.

16. The method of claim 6, wherein the silicon metal layer results from portions of the green coating that M is not removed.

17. The method of claim 6, wherein the porous silicon layer results from portions of the green coating that M is removed.
